(19) United States
(12) Patent Application Publication
(10) Pub. No.: US 2024/0139822 A1
(43) Pub. Date: May 2, 2024

(54) ROLL MOLD MANUFACTURING METHOD, ROLL MOLD, AND TRANSCRIPT

(71) Applicant: Dexerials Corporation, Shimotsuke-shi, Tochigi (JP)

(72) Inventors: Katsuhiro DOI, Shimotsuke-shi, Tochigi (JP); Kazuhiko NODA, Shimotsuke-shi, Tochigi (JP)

(73) Assignee: Dexerials Corporation, Shimotsuke-shi, Tochigi (JP)

(21) Appl. No.: 18/548,261

(22) PCT Filed: Mar. 25, 2022
(86) PCT No.: PCT/JP2022/014687

§ 371 Date: Aug. 29, 2023

(30) Foreign Application Priority Data
Mar. 30, 2021 (JP) 2021-057810
Mar. 23, 2022 (JP) 2022-047425

(51) Int. Cl. B23B 1/00

(52) U.S. Cl. CPC B23B 1/00

(57) ABSTRACT

A roll mold manufacturing method using a roll mold manufacturing apparatus, the apparatus comprising a rotary device configured to rotate a roll base material having either a tubular shape or a circular-column shape, and a predetermined machining stage comprising multiple cutting blades, the method comprising: a P cutting step of cutting a roll base material surface with a P cutting blade on the machining stage while moving the machining stage in a direction of an orientation P along the roll length direction; subsequently a step of switching from the P cutting blade to an N cutting blade on the machining stage; and subsequently an N cutting step of cutting the roll base material surface with the N cutting blade on the machining stage while moving the machining stage in a direction of another orientation N along the roll length direction.

### TECHNICAL FIELD

The present disclosure relates to a roll mold manufacturing method, a roll mold, and a transcript.

### BACKGROUND

Imprinting technology is one known microfabrication technology. In imprinting technology, an outer circumferential surface of a roll base material having either a tubular shape or a circular-column shape is machined to form a fine concavo-convex structure thereon and obtain a roll mold. The obtained roll mold is pressed against a resin sheet or resin film to transfer the fine concavo-convex structure on the roll base material. The roll mold is typically obtained by forming multiple grooves or a single groove (such as a spiral groove) on a surface (outer circumferential surface) of the roll base material by cutting with a cutting tool.

In cutting a roll base material surface, multiple linear grooves are usually formed along a circumferential direction (referred to as radial direction) of the roll base material and/or along a length direction (referred to as thrust direction) of the roll base material. Alternatively, multiple linear grooves may be formed along a direction that is inclined to a certain degree (referred to as oblique thrust direction) with respect to the length direction of the roll base material.

Several methods for precisely machining linear grooves on a roll base material surface have been reported. For example, Patent Literature (PTL) 1 discloses high-precision machining of three-dimensional patterns by combining a process of machining a surface of a rotary roll with a diamond turning tool to form a circumferential groove at a fixed pitch and a process of machining a roll surface while feeding a fly cutter along an axial direction of a roll to form an axial groove at a fixed pitch. The technology rotates the fly cutter at a high speed, thus giving the fly cutter an ideal cutting speed.

### PATENT LITERATURE

PTL 1: JP 2007-320022 A

### SUMMARY

### Technical Problem

When forming a groove along the thrust direction or the oblique thrust direction on the roll base material, it is necessary to cut the roll base material while moving the cutting tool along the length direction of the roll base material. The roll base material may be cut in directions of two cutting orientations along the length direction. The two cutting orientations include an orientation facing from an end A to an end B and an orientation facing from the end B to the end A, where the end A refers to one end of the roll base material and the end B refers to the other end of the roll base material. The mounting orientation of the cutting tool (cutting blade) to be brought into contact with the roll base material is determined depending on with which orientation the roll base material is cut. Similarly, when using the above-described fly cutter, the mounting orientation of the cutting blade of the fly cutter is determined by the direction of spindle rotation. Also, the cutting method is normalized to either up-cut or down-cut to make the states of the cutting surfaces consistent.

In other words, in conventional technology, once the cutting of the roll base material in the direction of the orientation from the end A to the end B is completed, the cutting tool needs to be temporarily retracted from the roll base material for the next cutting process, moved in a direction of reverse orientation, and returned to the original cutting start position. Thus, in the formation of thrust grooves or oblique thrust grooves to date, the cutting tool has had to be repositioned after each cut, and this has accounted for a large portion of the machining time of a series of roll molds.

In the case of using the above-described fly cutter, it is possible to cut the roll base material in the direction of the orientation from the end A to the end B and in the direction of the orientation from the end B to the end A without replacing the cutting tool. However, in such cases, it is difficult to make all states of the cutting surfaces consistent, which is an issue in terms of cutting accuracy.

It could be helpful to provide a roll mold manufacturing method that can form multiple grooves on a roll surface with high precision and shortened machining time.

It could also be helpful to provide a roll mold that can be manufactured by the above-described manufacturing method and a transcript obtainable by transcription using such a roll mold.

### Solution to Problem

A solution to the afore-mentioned issue is as follows.

<1> A roll mold manufacturing method using a roll mold manufacturing apparatus, the roll mold manufacturing apparatus comprising a rotary device 10 configured to rotate, along a circumferential direction, a roll base material having either a tubular shape or a circular-column shape, and a machining stage configured to be movable along a roll length direction and a roll radial direction,
wherein the machining stage comprises a switching stage placed thereon, the switching stage comprising multiple cutting blades and being capable of changing positions of the multiple cutting blades relative to the roll base material,
the roll mold manufacturing method comprising:
a P cutting step of cutting a roll base material surface with a P cutting blade on the machining stage while moving the machining stage in a direction of an orientation P along the roll length direction;
subsequently a step of switching from the P cutting blade to an N cutting blade on the machining stage; and
subsequently an N cutting step of cutting the roll base material surface with the N cutting blade on the machining stage while moving the machining stage in a direction of another orientation N along the roll length direction.

<2> The roll mold manufacturing method according to aspect <1>, wherein switching between the P cutting blade and the N cutting blade is performed by rotating the switching stage.

<3> The roll mold manufacturing method according to aspect <1> or <2>, wherein the P cutting blade and the N cutting blade are symmetrical to each other in cross section.

<4> The roll mold manufacturing method according to any one of aspects <1> to <3>, wherein the multiple cutting blades on the switching stage comprise only one each of the P cutting blade and the N cutting blade.

<5> The roll mold manufacturing method according to any one of aspects <1> to <4>, wherein the roll base material is rotated during at least one of the P cutting step and the N cutting step.

<6> The roll mold manufacturing method according to any one of aspects <1> to <5>, wherein the multiple cutting blades are diamond blades.

<7> The roll mold manufacturing method according to any one of aspects <1> to <6>, wherein the roll base material has a main component material, the main component material being a metal.

<8> A roll mold comprising multiple linear grooves on an outer circumferential surface thereof, the multiple linear grooves aligning and extending along a roll length direction or along a direction inclined to the roll length direction,
wherein the multiple linear grooves include a first group of linear grooves aligned in parallel at a first inclination angle and a second group of linear grooves aligned in parallel at a second inclination angle,
the first group of linear grooves and the second group of linear grooves intersect to form multiple intersections, and
the multiple intersections include an intersection P where burrs originating from cutting in a direction of an orientation P along the roll length direction are formed, and an intersection N where burrs originating from cutting in a direction of another orientation N along the roll length direction are formed.

<9> A transcript comprising a curable resin arranged on a substrate and multiple linear convex portions on a surface of the curable resin,
wherein the multiple linear convex portions include a first group of linear convex portions aligned in parallel to a first direction and a second group of linear convex portions aligned in parallel to a second direction,
the first group of linear convex portions and the second group of linear convex portions intersect to form multiple intersections,
a surface shape of the curable resin is an inverted shape of the outer circumferential surface of the roll mold according to aspect <8>.

### Advantageous Effect

It is possible to provide a roll mold manufacturing method that can form multiple grooves on a roll surface with high precision and shortened machining time.

It is also possible to provide a roll mold manufacturable by the above-described manufacturing method and a transcription obtainable by using the roll mold.

### BRIEF DESCRIPTION OF THE DRAWINGS

In the accompanying drawings:

FIG. 1 is a schematic diagram illustrating a configuration of a roll mold manufacturing apparatus that can be used for the roll mold manufacturing method;

FIG. 2A illustrates a state of the roll mold manufacturing apparatus 1 at the start of a P cutting step;

FIG. 2B illustrates a state of the roll mold manufacturing apparatus 1 at the end of the P cutting step;

FIG. 2C illustrates a state of the roll mold manufacturing apparatus 1 at the start of the N cutting step;

FIG. 2D illustrates a state of the roll mold manufacturing apparatus 1 at the end of the N cutting step;

FIG. 3 illustrates an arrangement of cutting blades in the machining stage of the roll mold manufacturing apparatus;

FIG. 4 illustrates a configuration of a conventional general roll mold manufacturing apparatus 1a;

FIG. 5 is a partial schematic diagram illustrating the cut surface in a roll mold of an embodiment according to the present disclosure;

FIG. 6 is a schematic representation of the cut surface in FIG. 5; and

FIG. 7 is a schematic representation of the cut surface in a roll mold of another embodiment according to the present disclosure.

### DETAILED DESCRIPTION

A roll mold and method according to the present disclosure are described in detail below based on embodiments.

### Roll Mold Manufacturing Method

A roll mold manufacturing method according to an embodiment of the present disclosure (hereinafter referred to as “the manufacturing method of the present embodiment”) uses a prescribed roll mold manufacturing apparatus to cut a surface of a roll base material having either a tubular shape or a circular-column shape. Such cutting can form linear grooves on the surface of the roll base material. The linear groove is not limited to a straight line.

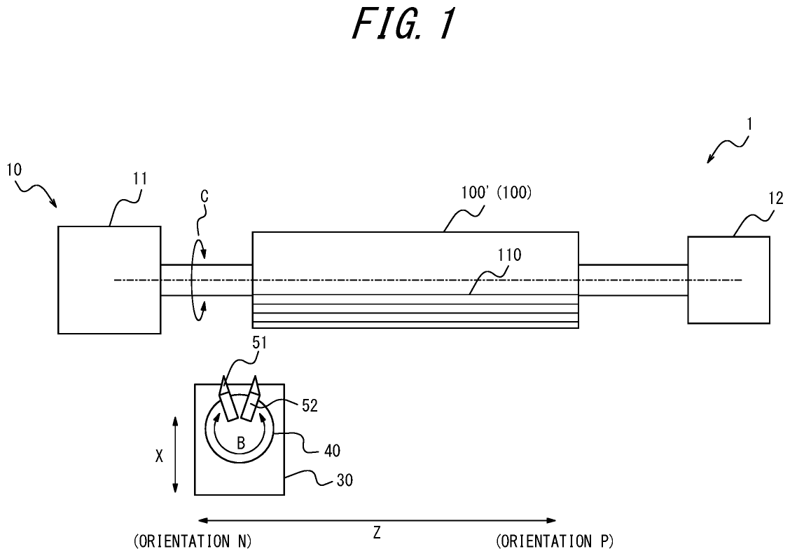

FIG. 1 is a schematic diagram illustrating a configuration of a roll mold manufacturing apparatus 1 that can be used for the manufacturing method of the present embodiment. As illustrated in FIG. 1, the roll mold manufacturing apparatus 1 includes a rotary device 10. The rotary device 10 is not particularly limited but includes a rotary drive unit 11 and a rotary driven unit 12. The rotary drive unit 11, the central axis of the roll base material 100′ to be cut, and the rotary driven unit 12 are arranged on the same axis (C-axis), such that the roll base material 100′ rotates along the circumferential direction. The rotary device 10 may incorporate an encoder or other mechanism to control the angle of rotation and speed of rotation as appropriate.

The roll base material 100′ has either a tubular shape or a circular-column shape. The roll base material 100′ may include internal circuits for cooling thereof. The roll base material 100′ may also include a coating layer on the surface thereof. In this case, a linear groove is formed in the coating layer. Coating layer materials may include, for example, nickel-phosphorus (Ni-P), and copper (Cu).

The main component material (when including a coating layer, the main component material is a foundation thereof) of the roll base material 100′ is preferably a metal. In this case, the rigidity of a roll mold (including the coating layer) to be produced can be maintained. Iron-based materials such as S45C and SUS304 are commonly used as the above main component material.

As illustrated in FIG. 1, the roll mold manufacturing apparatus 1 is equipped with a machining stage 30 on which cutting tools can be mounted. The machining stage 30 is movable along the Z-axis direction, which is parallel to the axis of rotation of the rotary device 10 (in other words, parallel to the length direction of the roll base material 100′). The machining stage 30 is also movable along the X-axis direction, which is parallel to the radial direction of the roll base material 100′ (may also be referred to as infeed axis direction or depth direction). Therefore, the roll mold manufacturing apparatus 1 is movable along the Z-axis direction (roll length direction) and the X-axis direction (roll radial direction) respectively by the machining stage 30, the cutting tool mounted on the machining stage 30 can be brought into contact with the surface of the roll base material 100′. Thus, by moving the machining stage 30 appropriately, the cutting tool can be brought into contact with and cut the surface of the roll base material 100′ to form a linear groove 110 (cut groove) on the surface of the roll base material 100′.

The roll mold manufacturing apparatus 1 used for the manufacturing method of the present embodiment features the machining stage 30 being equipped with multiple cutting blades (in FIG. 1, a first cutting blade 51 and a second cutting blade 52) and the multiple cutting blades being disposed on a switching stage 40 placed on the machining stage 30 so that positions of the multiple cutting blades relative to the roll base material 100′ are changeable. In other words, the above roll mold manufacturing apparatus 1 features the switching stage 40, which includes the multiple cutting blades and can change the positions of the multiple cutting blades relative to the roll base material 100′, being placed on the machining stage 30.

The switching stage 40 is not particularly limited but may have a mechanism that rotates around a B-axis, which is perpendicular to the X-Z plane, as illustrated in FIG. 1. The switching stage 40 can precisely control the angle of rotation around the B-axis, and the multiple cutting blades (the first cutting blade 51 and the second cutting blade 52) are aligned and mounted such that tips thereof face in the radial direction of the B-axis. Therefore, by rotating the switching stage 40 around the B-axis, the position of each cutting blade relative to the roll base material 100′ can be changed on the machining stage 30. Further, the first cutting blade 51 and the second cutting blade 52 are not particularly limited but are mounted on the switching stage 40 in reversed orientations to each other.

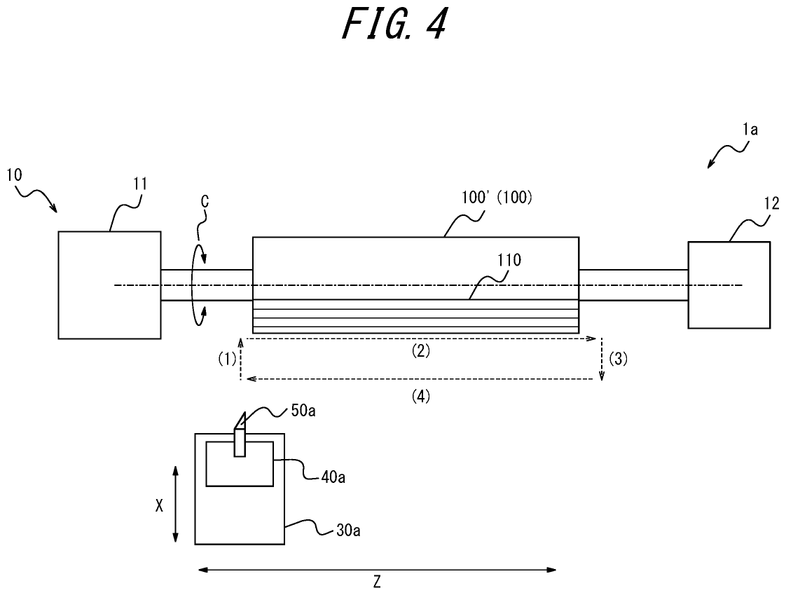

As a comparison, FIG. 4 illustrates a configuration of a conventional general roll mold manufacturing apparatus 1a. The configuration of the roll mold manufacturing apparatus 1a in FIG. 4 differs from the configuration of the roll mold manufacturing apparatus 1a in FIG. 1, particularly in that the machining stage is movable along the Z-axis direction and X-axis direction, a tool installation section 40a is installed on the machining stage 30a, and a cutting blade 50a is simply mounted on the tool installation section 40a.

When using such a conventional roll mold manufacturing apparatus 1a to form grooves along the length direction (thrust direction) of the roll base material 100′ or along the direction inclined to a certain degree to the length direction of the roll base material 100′ (the oblique thrust direction), it is necessary to determine beforehand a cutting orientation of the roll base material 100′ (i.e., an orientation from a rotary drive unit 11 side to a rotary driven unit 12 side or an orientation from the rotary driven unit 12 side to the rotary drive unit 11 side) and, based thereon, determine the appropriate mounting orientation for the cutting tool (the cutting blade). Therefore, for example, when forming multiple linear grooves by cutting the roll base material 100′ in the direction of the orientation from the rotary drive unit 11 side to the rotary driven unit 12 side, specifically, it is necessary to repeat the following processes (1) through (4) (corresponding to the bracketed numbers in FIG. 4. The dotted arrows in FIG. 4 represent the schematic trajectory of a cutting blade 50a).
(1) The machining stage 30a is moved along the X-axis direction (in a direction of an orientation proximal to the roll base material 100′) to bring the cutting blade 50a to a groove depth position.
(2) The machining stage 30a is moved along the Z-axis direction (in a direction of an orientation from the rotary drive unit 11 side to the rotary driven unit 12 side) to cut the roll base material 100′ surface with the cutting blade 50a.
(3) The machining stage 30a is moved along the X-axis direction (in a direction of an orientation distal to the roll base material 100′) to retract the cutting blade 50a from the roll base material 100′.
(4) The machining stage 30a is moved along the Z-axis direction (in a direction of an orientation from the rotary driven unit 12 side to the rotary drive unit 11 side) to return the cutting blade 50a to the cutting start position.

On the other hand, in the manufacturing method of the present embodiment, the use of a roll mold manufacturing apparatus such as the roll mold manufacturing apparatus 1 illustrated in FIG. 1 can omit the operation of returning the cutting blade to the cutting start position and shorten the machining time in comparison with conventional methods.

That is, the manufacturing method of the present embodiment uses the roll mold manufacturing apparatus 1 as illustrated in FIG. 1, and includes:
a P cutting step of cutting a surface of the roll base material 110′ with a P cutting blade (in FIG. 1, the first cutting blade 51) on the machining stage 30 while moving the above machining stage 30 in a direction of an orientation P along the roll length direction,
subsequently a step of switching from the P cutting blade to the N cutting blade (the second cutting blade 52 in FIG. 1) on the above machining stage 30, and
subsequently an N cutting step of cutting the roll base material 110′ surface with the N cutting blade on the above machining stage 30 while moving the above machining stage 30 in a direction of another orientation N along the roll length direction.

The terms “orientation P” and “orientation N” above for the roll length direction are derived from the words “Positive” and “Negative”, respectively. However, these terms are given for ease of explanation and are not intended to be distinguished from one another. For ease of explanation, however, P refers to an orientation facing along the roll length direction from the rotary drive unit 11 side to the rotary driven unit 12 side, and N refers to an orientation facing from the rotary driven unit 12 side to the rotary drive unit 11 side.

As one example, the following describes a method of forming multiple linear grooves along the length direction (thrust direction) of the roll base material 100′ using the roll mold manufacturing apparatus 1 illustrated in FIG. 1

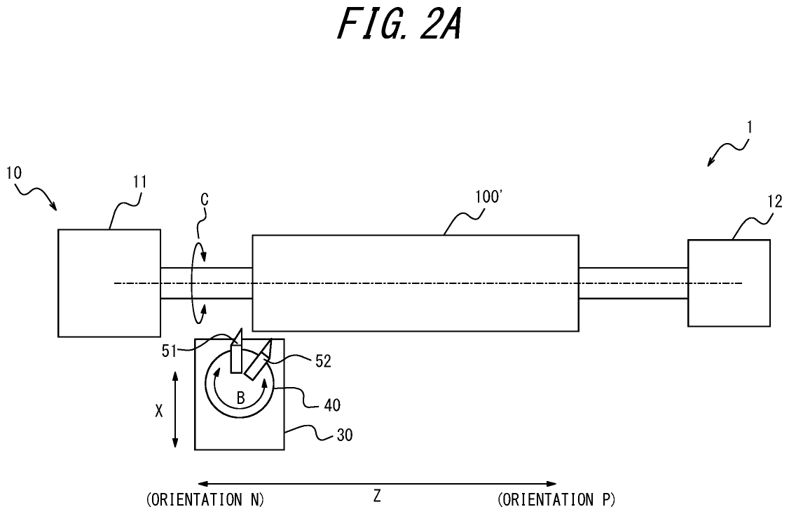

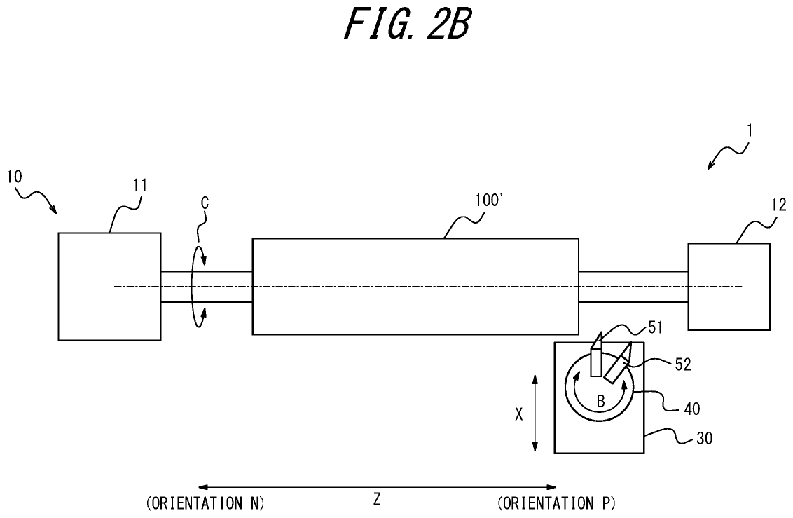

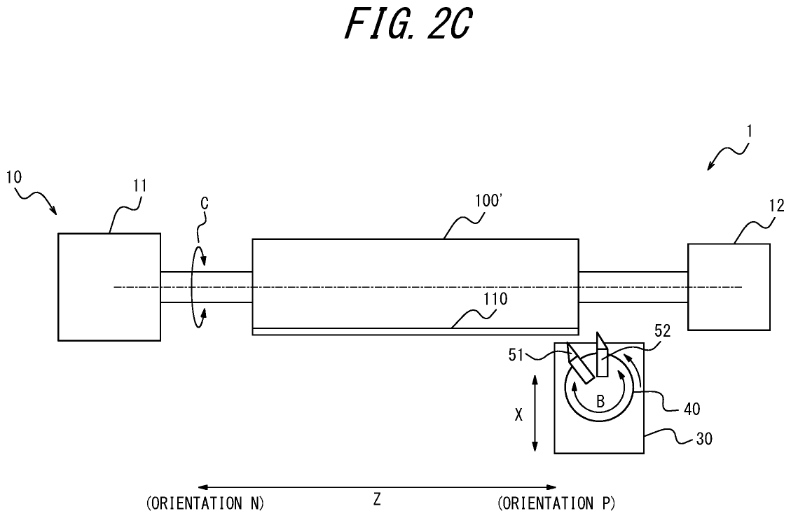

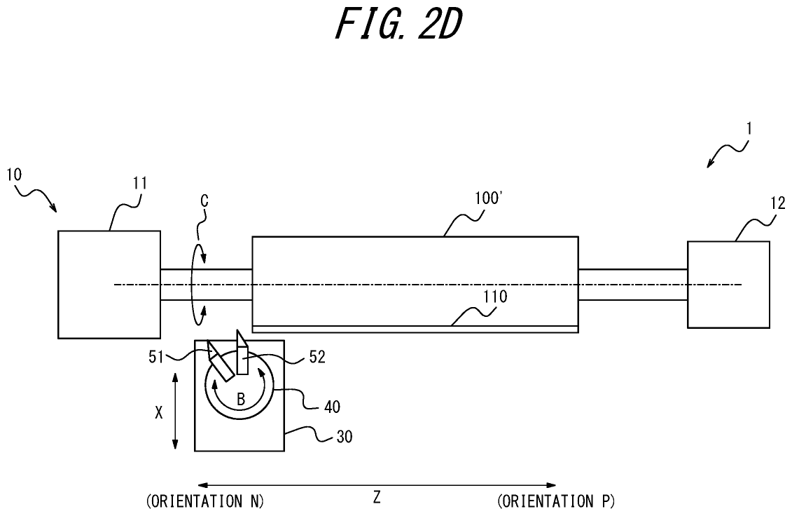

FIG. 2A illustrates a state of the roll mold manufacturing apparatus 1 at the start of the P cutting step. In FIG. 2A, due to the switching by the switching stage 40 on the machining stage 30, the first cutting blade 51 faces the rotary device 10 and is in a standby cutting position along the roll length direction, some distance away from the roll base material 100′ in the direction of the orientation N. On the other hand, the second cutting blade 52 is in a retracted state due to the switching by the switching stage 40. Furthermore, in FIG. 2A, the first cutting blade 51 has reached the depth position of the groove to be formed (by the machining stage 30 moving along the X-axis direction).

During the P cutting step, the first cutting blade 51 on the machining stage 30 cuts the roll base material 100′ surface while the machining stage 30 moves in the direction of the orientation P along the roll length direction from the state illustrated in FIG. 2A. This thereby forms a single linear groove 110. To form a linear groove extending along the thrust direction, the roll base material 100′ is fixed with the rotary device 10 so as not to allow the roll base material 100′ to rotate around the C-axis.

FIG. 2B illustrates the state of the roll mold manufacturing apparatus 1 at the end of the P cutting step. During the P cutting step, the movement of the machining stage 30 in the direction of the orientation P can be brought to a stop at a position a certain distance away in the direction of the orientation P from the roll base material 100′ where the first cutting blade 51 completes cutting the roll base material 100′ as illustrated in FIG. 2B.

After the P cutting step, the first cutting blade 51 is switched to the second cutting blade 52 on the machining stage 30. FIG. 2C illustrates a state of the roll mold manufacturing apparatus 1 at that time. In FIG. 2C, the switching stage 40 rotates around the B-axis such that the second cutting blade 52 enters a cutting standby state facing the rotary device 10 while the first cutting blade 51 enters a retracted state.

After the P cutting step, the roll base material 100′ can be rotated, by the rotary device 10, along the C-axis direction by one pitch of the linear groove to be formed, and then fixed.

During the N cutting step, the second cutting blade 52 on the machining stage 30 cuts the roll base material 100′ surface while the machining stage 30 moves in the direction of the orientation N along the roll length direction from the state illustrated in FIG. 2C. This thereby forms a single linear groove 110.

FIG. 2D illustrates a state of the roll mold manufacturing apparatus 1 at the end of the N cutting step. During the N cutting step, the movement of the machining stage 30 in the direction of the orientation N can be brought to a stop at a position a certain distance away in the direction of the orientation N from the roll base material 100′ where the second cutting blade 52 completes cutting the roll base material 100′ as illustrated in FIG. 2D.

After the N cutting step, the second cutting blade 52 can be switched to the first cutting blade 51 on the machining stage 30. In this example, the switching stage 40 rotates around the B-axis (in a reverse direction from the previous example) such that the first cutting blade 51 enters a cutting standby state facing the rotary device 10 while the second cutting blade 52 enters a retracted state.

After the N cutting step, the roll base material 100′ can be rotated, by the rotary device 10, along in the C-axis direction by one pitch of the linear groove to be formed, and then fixed.

The above process (the P cutting step, the switching of the cutting blades, the N cutting step, and the switching of the cutting blades) constitutes one turn, and the turn is repeated multiple times as necessary. Thus, a roll mold 100 with multiple linear grooves along the roll length direction (thrust direction) can eventually be obtained. The above turn can be performed without the operation of moving the machining stage 30 along the roll radial direction (X-axis direction).

Thus, in the manufacturing method of the present embodiment, the multiple cutting blades mounted on the switching stage 40 are switched as needed to enable alternating cutting in a direction of an orientation (the orientation P) and a direction in another orientation (the orientation N) along the roll length direction. Therefore, the time previously required to retract the cutting blade from the roll base material and return the cutting blade to the cutting start position can be spent on the cutting in the present embodiment, thus significantly reducing the machining time.

In the manufacturing method of the present embodiment, the P cutting blade is attached to the switching stage in an orientation suitable for the P cutting step, and the N cutting blade is attached to the switching stage in an orientation suitable for the N cutting step. For example, the P cutting blade and N cutting blade can be mounted on the switching stage so that the P cutting blade and N cutting blade contact the roll base material 100′ in reversed orientations to each other. Thereby, the states of the groove cut by the P cutting step and the groove cut by the N cutting step can be made consistent, which enables multiple grooves (thrust grooves or oblique thrust grooves) to be formed with high precision on the roll surface.

The multiple cutting blades are used together in the manufacturing method of the present embodiment, and thus the cutting distance per cutting blade can be reduced. As a result, the loss of shape of the cutting surface due to wear can also be significantly suppressed.

In the above method, the roll base material is fixed such that the roll base material does not rotate around the C-axis during the P cutting step and the N cutting step, thereby forming multiple linear grooves along the length direction (thrust direction) of the roll base material. However, the manufacturing method of the present embodiment is not limited thereto, and the roll base material may be rotated during at least one of the P cutting step and the N cutting step. Thus, when the roll base material is cut while rotating, a linear groove extending along a direction inclined to the length direction of the roll base material (the oblique thrust direction) can be formed.

The switching stage 40 equipped with the multiple cutting blades is not particularly limited as long as the positions of the multiple cutting blades relative to the roll base material can be changed. For example, one switching stage can be disposed for one cutting blade, and each switching stage is independently moveable on the machining stage 30. A movable stage such as in the above case may be a piezo stage or similar stage.

In the manufacturing method of the present embodiment, the switching between the P cutting blade and the N cutting blade (or the switching of the multiple cutting blades) is preferably performed by rotating the switching stage as it can facilitate the operation for switching between the P cutting blade and the N cutting blade (or switching between the multiple cutting blades). Such switching can be performed, for example, by the switching stage 40 illustrated in FIG. 1.

When using the switching stage 40 illustrated in FIG. 1, the first cutting blade 51 and the second cutting blade 52 are preferably mounted on the switching stage such that when one cutting blade is cutting, the other cutting blade is retracted. Specifically, an angle formed by the multiple cutting blades (the first cutting blade 51 and the second cutting blade 52) is preferably 5° or more, depending on the depth of the groove to be formed. The above angle is preferably 15° or less from the viewpoint of shortening the switching operation time.

The number of blades in the multiple cutting blades on the switching stage is not particularly limited but preferably includes only one each of the P cutting blade and the N cutting blade as illustrated in FIG. 1, etc. This is advantageous in that the operation of switching from the P cutting blade to the N cutting blade (or vice versa) can be facilitated in a short time.

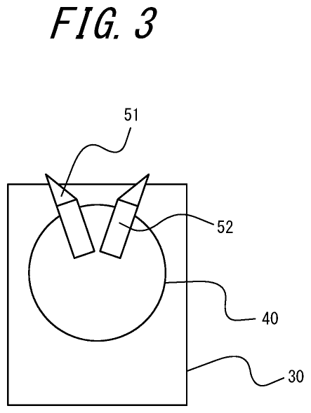

The first cutting blade 51 and the second cutting blade 52 in FIG. 1 and FIG. 2 are aligned and mounted facing each other such that the cutting blades thereof are close to each other. However, without being limited thereto, the first cutting blade 51 and the second cutting blade 52 may be aligned and mounted facing each other such that the cutting blades thereof face away from each other, as illustrated in FIG. 3.

In the manufacturing method of the present embodiment, the P cutting blade and the N cutting blade are preferably symmetrical to each other in cross section. In this case, the uniformity of the state of the grooves cut by the P cutting step and the N cutting step is improved, and the accuracy of the multiple grooves (thrust grooves or oblique thrust grooves) formed on the roll surface can be further increased.

The above “symmetrical” includes being identical.

Materials for the cutting blades include diamond, cemented carbide, high-speed tool steel, cubic boron nitride (CBN), etc., and cutting blades can be manufactured by grinding these materials. Cutting blades can also be manufactured by laser irradiation, ion milling, etc. In particular, the multiple cutting blades used in the present embodiment are preferably diamond blades from the viewpoint of high wear resistance and the accuracy of the machined surface (including dimensional accuracy and surface roughness).

The tips of the cutting blades can be tapered. The tips of the cutting blades are pressed against the roll base material 100′ to cut the surface of the roll base material 100′. The shapes of the linear grooves 110 formed in the roll base material 100′ then correspond to the shapes of the tips of the cutting blades.

In addition to forming linear grooves extending along the thrust direction or the oblique thrust direction on the roll base material, the manufacturing method of the present embodiment may further form linear grooves along the circumferential direction (a radial direction) of the roll base material. Linear grooves in the radial direction can be formed, for example, by cutting the roll base material while rotating the roll base material around the C-axis, without moving the cutting blade along the roll length direction.

### Roll Mold

The roll mold according to an embodiment of the present disclosure (hereinafter referred to as “the roll mold of the present embodiment”) is a roll mold comprising multiple linear grooves on an outer circumferential surface thereof, the multiple linear grooves aligning and extending along a roll length direction or along a direction inclined to the roll length direction,
the multiple linear grooves include a first group of linear grooves aligned in parallel at a first inclination angle and a second group of linear grooves aligned in parallel at a second inclination angle,
the first group of linear grooves and the second group of linear grooves intersect to form multiple intersections, and
the multiple intersections include an intersection P where burrs originating from cutting in the direction of the orientation P along the roll length direction are formed, and an intersection N, where burrs originating from cutting in the direction of the other orientation N along the roll length direction are formed.

The roll mold of the present embodiment substantially corresponds to the roll mold manufactured by the above-described manufacturing method of the present embodiment. More specifically, the roll mold of the present embodiment can be manufactured by forming multiple intersecting thrust grooves or oblique thrust grooves on the outer circumferential surface while repeatedly and alternatingly cutting in the direction of the orientation P (the P cutting step) and cutting in the direction of the orientation N (the N cutting step).

Normally, when a new linear groove is formed by cutting to intersect an already formed linear groove, burrs are caused on the cutting surface on the exit side of the later-formed linear groove on the intersection point (crossing point). These burrs are a phenomenon due to manufacturing technology and thus cannot be completely eliminated.

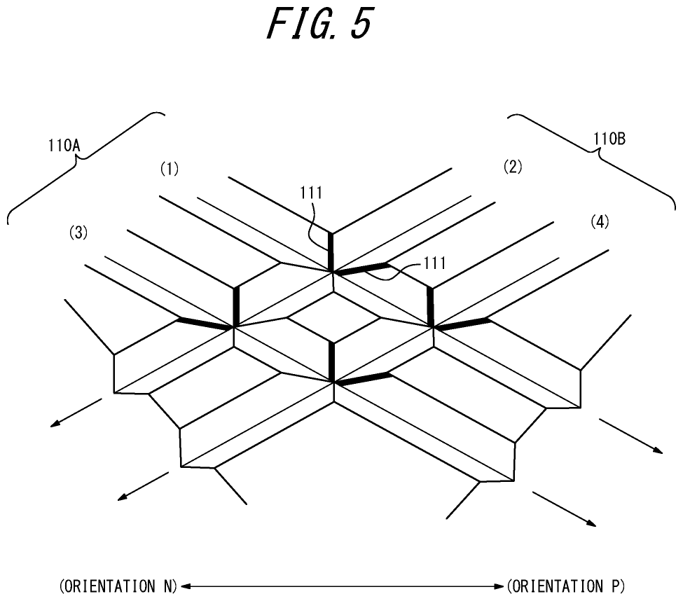

FIG. 5 illustrates a partial, schematic view of the cut surface in this roll mold. As outlined in FIG. 5, the roll mold of the present embodiment includes the first group of linear grooves 110A parallel to the roll length direction at the first inclination angle and the second group of linear grooves 110B parallel to the roll length direction at the second inclination angle. The first group of linear grooves 110A and the second group of linear grooves 110B intersect each other, thereby forming multiple intersections (four in FIG. 5). One of the first group of linear grooves 110A and the second group of linear grooves 110B may be parallel to the roll length direction (i.e., the inclination angle is 0°).

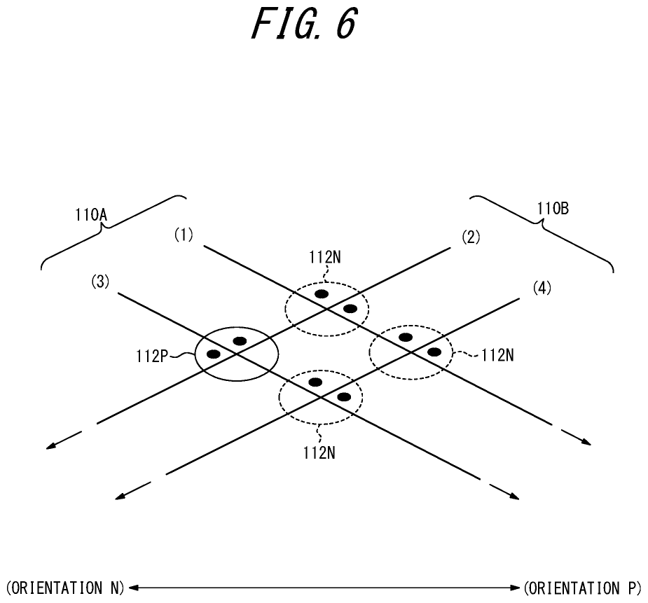

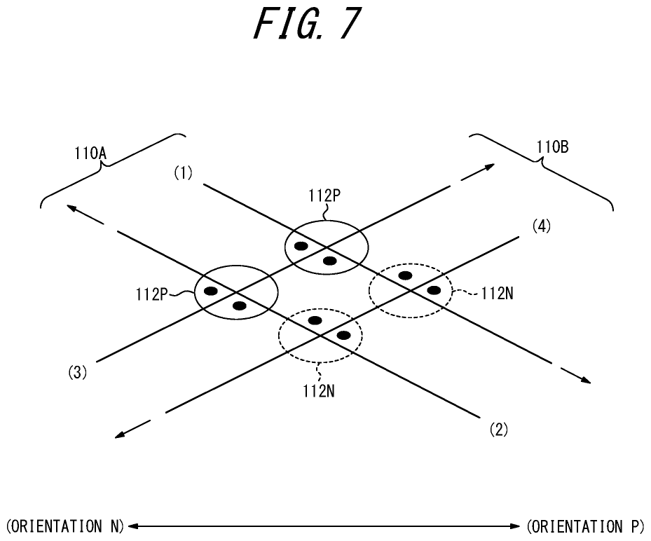

Here, in FIG. 5 (and FIG. 6 and FIG. 7), the bracketed numbers ((1) through (4)) indicate the order of cutting in the manufacturing of roll molds, and the arrows indicate the directions of the cutting orientation. In FIG. 5, the cuttings are made alternately in a direction of an orientation (the orientation P) and in a direction of another orientation (the orientation N) along the roll length direction. The second cutting cuts in the direction of the orientation N to intersect the already formed first cut groove, which causes burrs 111 on the cutting surface on the exit side of the second cut groove at the intersection of the first and second cut grooves. Similarly, the third cutting cuts in the direction of the orientation P to intersect the already formed second cut groove, which causes burrs 111 on the cutting surface on the exit side of the third cut groove at the intersection of the second and third cut grooves. Similarly, the fourth cutting cuts in the direction of the orientation N to intersect the already formed first cut groove and then the third cut groove, which causes burrs 111 on each of the cutting surface on the exit side of the fourth cut groove at the intersection of the first and fourth cut grooves and the cutting surface on the exit side of the fourth cut groove at the intersection of the third and fourth cut grooves.

FIG. 6 is a schematic representation of the cut surface in FIG. 5. On the cut surface, the first group of linear grooves 110A and the second group of linear grooves 110B intersect to form multiple intersections 112. The multiple intersections 112 include the intersection P (112P, circled by solid line), where burrs 111 originating from cutting in the direction of the orientation P are formed due to the cutting as described above, and the intersection N (112N, circled by dashed line), where burrs originating from cutting in the direction of the orientation N are formed.

FIG. 7 is a schematic representation of the cut surface in another embodiment of the roll mold, similar to FIG. 6. FIG. 7 is similar to FIG. 6 in that cutting in the direction of the orientation P alternates with cutting in the direction of the orientation N, but the order, in which the linear grooves are formed, differs from FIG. 6. The multiple intersections 112 in FIG. 7 also include the intersection P (112P, circled by solid line), where burrs 111 originating from cutting in the direction of the orientation P are formed, and the intersection N (112N, circled by dashed line), where burrs derived from cutting in the direction of the orientation N are formed.

The roll mold of the present embodiment, which is obtained by forming multiple intersecting thrust grooves or oblique thrust grooves on the outer circumferential surface while repeatedly and alternately the cutting in the direction of the orientation P (the P cutting step) and the cutting in the direction of the orientation N (the N cutting step) as described above, is novel compared to a roll mold manufactured with a conventional roll mold manufacturing apparatus.

In the present specification, the “cutting in the direction of the orientation P” includes cutting in a direction of an orientation that includes a vector component in the direction of the orientation P. Similarly, the “cutting in the direction of the orientation N” includes cutting in a direction of an orientation that includes a vector component in the direction of the orientation N.

The intersection P, where the burrs originating from the cutting in the direction of the orientation P are formed, is preferably free of burrs originating from the cutting in the direction of the orientation N. Similarly, the intersection N, where the burrs originating from the cutting in the direction of the orientation N are formed, is preferably free of burrs originating from the cutting in the direction of the orientation P.

The main component material of the roll mold according to the present embodiment is the same as the main component material already described for the roll base material 100′.

The roll mold according to the present embodiment preferably has multiple linear grooves (the first group of linear grooves and/or the second group of linear grooves) equally spaced with a predetermined pitch and a certain amount of acceptable pitch error. In a variation of a design of the roll mold, the multiple linear grooves (the first group of linear grooves and/or the second group of linear grooves) may be formed with a random pitch.

In addition to the linear grooves extending along the roll length direction or along a direction inclined to the roll length direction, the roll mold according to the present embodiment may include multiple linear grooves along the roll circumferential direction.

The structure of the linear grooves can be measured by forming, via transcription, linear convex portions on the resin corresponding to the linear grooves and by observing the cross-sections of the linear convex portions with an optical microscope such as a laser microscope, or with an electron microscope such as a scanning electron microscope (SEM). Burrs can be identified by observing the intersections of the linear grooves in the roll mold with a microscope.

In the roll mold according to the present embodiment, the number of the multiple linear grooves is not particularly limited and can be 800 or more and 100,000 or less.

The diameter of the roll mold according to the present embodiment is not particularly limited and can be, for example, 130 mm or more and 1,000 mm or less. The pitches of the linear grooves (the first group of linear grooves and the second group of linear grooves) in the roll mold according to the present embodiment are not particularly limited and can be, for example, 30 μm or more and 500 μm or less independently of each other.

### Transcript

A transcript according to an embodiment of the present disclosure (hereinafter referred to as “the transcript of the present embodiment”) is a transcript comprising a curable resin, which is arranged on a substrate, and multiple linear convex portions, which are provided on a surface of the curable resin,
the multiple linear convex portions include a first group of linear convex portions aligned in parallel to a first direction and a second group of linear convex portions aligned in parallel to a second direction,
the first group of linear convex portions and the second group of linear convex portions intersect to form multiple intersections,
the surface shape of the curable resin is the inverted shape of the above-described outer circumferential surface of the roll mold.

The transcript according to the present embodiment can be manufactured by using the roll mold according to the present embodiment to transfer a surface shape thereof to a curable resin arranged on a substrate (shape transfer method). Therefore, the shape of a transfer surface of the transcript according to the present embodiment corresponds to an inverted shape of the outer circumferential surface of the roll mold according to the present embodiment. Specifically, the shapes of the multiple linear convex portions of the transcript according to the present embodiment correspond to inverted shapes of the multiple linear grooves of the roll mold according to the present embodiment.

Shape transfer methods include, for example, melt transfer, thermal transfer, and UV (ultraviolet) transfer.

The transcript according to the present embodiment can be sheet-shaped (a transfer sheet or a transfer film).

Materials for the substrate include, for example, acrylic resin (polymethyl methacrylate, etc.), polycarbonate, PET (polyethylene terephthalate), TAC (triacetylcellulose), polyethylene, polypropylene, cycloolefin polymer, cycloolefin copolymer, polyvinyl chloride.

Curable resins include epoxy curable resins, acrylic curable resins, and other UV-curable resins. The curable resin may be blended with fillers, functional additives, inorganic substances, pigments, antistatic agents, sensitizing dyes, etc. as needed.

The structure of the linear convex portions can be measured by observing the cross sections thereof with an optical microscope such as a laser microscope, or an electron microscope such as a scanning electron microscope (SEM).

The pitches of the multiple linear convex portions (the first group of linear convex portions and the second group of linear convex portions) in the transcript according to the present embodiment are not particularly limited and can be, for example, 30 μm or more and 500 μm or less independently of each other.

### EXAMPLES

Our roll mold manufacturing method, roll mold, and transcript are described in detail by way of the following examples and comparative examples, but are not restricted to the following examples.

### Comparative Example 1

A roll mold manufacturing apparatus having the configuration illustrated in FIG. 4 was prepared. Specifically, the roll base material 100′ was made of metal and had a diameter of 250 mm, a length of 1,350 mm, and a circular-column shape. The cutting blade 50a was a diamond blade. The cutting orientation was determined to be the orientation facing from the rotary drive unit 11 side to the rotary driven unit 12 side, and then the above-described processes (1) to (4), which constitute one turn, were repeated for 8,000 turns, with the operation of rotating the roll base material 100′ by the pitch being performed as appropriate therebetween. Thus, 8,000 linear grooves along the thrust direction were formed on the roll base material surface.

As a result, the time per turn was approximately 15 seconds, and the total machining time was approximately 32 hours.

### Example 1

A roll mold manufacturing apparatus having the configuration illustrated in FIG. 1 was prepared. Specifically, the roll mold manufacturing apparatus was provided with a machining stage 30 that is movable along each of the Z-axis direction (roll length direction) and the X-axis direction (roll radial direction). The switching stage 40, which has a mechanism configured to rotate around the B-axis perpendicular to the X-Z plane and has the first cutting blade 51 and second cutting blade 52 aligned and mounted with their tips facing along the radial direction of the B-axis, was placed on the machining stage 30. The first cutting blade 51 and second cutting blade 52 were mounted on the switching stage 40 in reversed orientations to each other and at a separation of 6°. Due to this spatial arrangement, when one cutting blade is parallel to the X-axis (facing the roll base material 100′) and cutting to a predetermined depth, the other cutting blade is retracted from the roll base material. The roll base material 100′ was the same as in Comparative Example 1, and the material of the two cutting blades was also the same as in Comparative Example 1.

At the start of the P cutting step, the switching stage 40 was rotated around the B-axis in advance so that the first cutting blade 51 was parallel to the X-axis, and at the start of the N cutting step, the switching stage 40 was rotated around the B-axis in advance so that the second cutting blade 52 was parallel to the X-axis. Then, the previously described “the P cutting step, the switching of the cutting blades, the N cutting step, and the switching of the cutting blades”, which constitute one turn, were repeated for 8000 turns. Thus, 8,000 linear grooves along the thrust direction were formed on the roll base material surface such that the cutting pattern was the same as in Comparative Example 1.

As a result, the total machining time was approximately 20 hours. In other words, the manufacturing method of the present disclosure reduced the machining time for the formation of linear grooves along the thrust direction by approximately 12 hours compared to the conventional method.

### Comparative Example 2

In the present example, a roll mold manufacturing apparatus with the configuration illustrated in FIG. 4 was used, a V-shaped diamond bit was used as the cutting blade 50a, and multiple linear grooves were formed along a direction inclined at 30° to the length direction of the roll base material and along a direction inclined at −30° to the length direction of the roll base material (oblique thrust directions). Specifically, the cutting orientation was determined to be the orientation facing from the rotary drive unit 11 side to the rotary driven unit 12 side, and then the above-described processes (1) to (4) were repeated for multiple turns to form multiple linear grooves along one direction on the roll base material surface. After groove formation along that direction was completed, the cutting orientation was determined to be the orientation facing from the rotary drive unit 11 side to the rotary driven unit 12 side, and then the above-described processes (1) to (4) were repeated for multiple turns to form multiple linear grooves along another direction on the roll base material surface. In the resulting roll molds, linear grooves along a direction inclined at 30° to the roll length direction and linear grooves along a direction inclined at −30° to the roll length direction intersect to form tetragonal convex portions.

As a result, the total machining time was approximately 75 hours.

### Example 2

In the present example, a roll mold manufacturing apparatus with the configuration illustrated in FIG. 1 was used, and the same operations as in Example 2 were appropriately performed while rotating the roll base material. Thus, the cutting pattern was the same as in Comparative Example 2, and multiple linear grooves were formed along a direction inclined at 30° to the length direction of the roll base material and along a direction inclined at −30° to the length direction of the roll base material (oblique thrust directions).

As a result, the total machining time was approximately 46 hours. In other words, the manufacturing method of the present disclosure reduced the machining time for the formation of linear grooves along the oblique thrust directions by approximately 29 hours compared to the conventional method.

### INDUSTRIAL APPLICABILITY

It is possible to provide a roll mold manufacturing method that can form multiple grooves on a roll surface with high precision and shortened machining time.

It is also possible to provide a roll mold manufacturable by the above-described manufacturing method and a transcription obtainable by using the roll mold.

### REFERENCE SIGNS LIST

1 Roll mold manufacturing apparatus
10 Rotary device
11 Rotary drive unit
12 Rotary driven unit
30 Machining stage
40 Switching stage
51 First cutting blade
52 Second cutting blade
100′ Roll base material
100 Roll mold
110 Linear grooves
110A First group of linear grooves
110B Second group of linear grooves
111 Burr
112P, 112N Intersection

1. A roll mold manufacturing method using a roll mold manufacturing apparatus, the roll mold manufacturing apparatus comprising a rotary device configured to rotate, along a circumferential direction, a roll base material having either a tubular shape or a circular-column shape, and a machining stage configured to be movable along a roll length direction and a roll radial direction,
wherein the machining stage comprises a switching stage placed thereon, the switching stage comprising multiple cutting blades and being capable of changing positions of the multiple cutting blades relative to the roll base material,
the roll mold manufacturing method comprising:
a P cutting step of cutting a roll base material surface with a P cutting blade on the machining stage while moving the machining stage in a direction of an orientation P along the roll length direction;
subsequently a step of switching from the P cutting blade to an N cutting blade on the machining stage; and
subsequently an N cutting step of cutting the roll base material surface with the N cutting blade on the machining stage while moving the machining stage in a direction of another orientation N along the roll length direction.

2. The roll mold manufacturing method according to claim 1, wherein switching between the P cutting blade and the N cutting blade is performed by rotating the switching stage.

3. The roll mold manufacturing method according to claim 1, wherein the P cutting blade and the N cutting blade are symmetrical to each other in cross section.

4. The roll mold manufacturing method according to claim 1, wherein the multiple cutting blades on the switching stage comprise only one each of the P cutting blade and the N cutting blade.

5. The roll mold manufacturing method according to claim 1, wherein the roll base material is rotated during at least one of the P cutting step and the N cutting step.

6. The roll mold manufacturing method according to claim 1, wherein the multiple cutting blades are diamond blades.

7. The roll mold manufacturing method according to claim 1, wherein the roll base material has a main component material, the main component material being a metal.

8. A roll mold comprising multiple linear grooves on an outer circumferential surface thereof, the multiple linear grooves aligning and extending along a roll length direction or along a direction inclined to the roll length direction,
wherein the multiple linear grooves include a first group of linear grooves aligned in parallel at a first inclination angle and a second group of linear grooves aligned in parallel at a second inclination angle,
the first group of linear grooves and the second group of linear grooves intersect to form multiple intersections, and
the multiple intersections include an intersection P where burrs originating from cutting in a direction of an orientation P along the roll length direction are formed, and an intersection N where burrs originating from cutting in a direction of another orientation N along the roll length direction are formed.

9. A transcript comprising a curable resin arranged on a substrate and multiple linear convex portions on a surface of the curable resin,
wherein the multiple linear convex portions include a first group of linear convex portions aligned in parallel to a first direction and a second group of linear convex portions aligned in parallel to a second direction,
the first group of linear convex portions and the second group of linear convex portions intersect to form multiple intersections,
a surface shape of the curable resin is an inverted shape of the outer circumferential surface of the roll mold according to claim 8.

10. The roll mold manufacturing method according to claim 2, wherein the P cutting blade and the N cutting blade are symmetrical to each other in cross section.

11. The roll mold manufacturing method according to claim 2, wherein the multiple cutting blades on the switching stage comprise only one each of the P cutting blade and the N cutting blade.

12. The roll mold manufacturing method according to claim 2, wherein the roll base material is rotated during at least one of the P cutting step and the N cutting step.

13. The roll mold manufacturing method according to claim 2, wherein the multiple cutting blades are diamond blades.

14. The roll mold manufacturing method according to claim 2, wherein the roll base material has a main component material, the main component material being a metal.

15. The roll mold manufacturing method according to claim 3, wherein the multiple cutting blades on the switching stage comprise only one each of the P cutting blade and the N cutting blade.

16. The roll mold manufacturing method according to claim 3, wherein the roll base material is rotated during at least one of the P cutting step and the N cutting step.

17. The roll mold manufacturing method according to claim 3, wherein the multiple cutting blades are diamond blades.

18. The roll mold manufacturing method according to claim 3, wherein the roll base material has a main component material, the main component material being a metal.

19. The roll mold manufacturing method according to claim 4, wherein the roll base material is rotated during at least one of the P cutting step and the N cutting step.

20. The roll mold manufacturing method according to claim 4, wherein the multiple cutting blades are diamond blades.
